(19) United States
(12) Patent Application Publication
(10) Pub. No.: US 2023/0391054 A1
(43) Pub. Date: Dec. 7, 2023

(54) GLAZING HAVING LIGHTING CAPABILITIES

(71) Applicant: CARLEX GLASS LUXEMBOURG S.A., Grevenmacher (LU)

(72) Inventor: Markus Walter POHLEN, Mückeln (DE)

(21) Appl. No.: 18/249,175

(22) PCT Filed: Oct. 15, 2021
(86) PCT No.: PCT/EP2021/078711

§ 371 Date: Apr. 14, 2023

Related U.S. Application Data
(60) Provisional application No. 63/092,707, filed on Oct. 16, 2020.

(51) Int. Cl. B32B 17/10; F21V 8/00; B60J 1/00; B60Q 3/208

(52) U.S. Cl. CPC B32B 17/10541; B32B 17/10036; B32B 17/10798; B32B 17/10779; B32B 17/10504; B32B 17/10293; B32B 17/10761; G02B 6/0088; G02B 6/0065; B60J 1/001; B60Q 3/208; B32B 2605/08; B32B 2250/05

(57) ABSTRACT

A laminated glazing including first and second glass sheets, a light guide between the glass sheets, a light source for introducing light into the light guide film, and first and second adhesive layers around the light guide film, wherein the light guide film extends out of the first and second glass sheets.

### CROSS REFERENCE TO RELATED APPLICATIONS

This application claims priority to U.S. Provisional Application No. 63/092,707 filed on Oct. 16, 2020, entitled “GLAZING HAVING LIGHTING CAPABILITIES,” the entire contents of which are incorporated by reference herein in their entirety.

### TECHNICAL FIELD

This disclosure generally relates to a laminated glazing, particularly a vehicle sunroof, having a lighting capability.

### BACKGROUND

Automotive glazings having luminous capability are known in the art, including those taught in EP Patent Pub. No. 2401639 and U.S. Patent Pub. Nos. 2015/0298601 and 2007/0098969. Conventional glazing designs have included a light source positioned at an edge portion of glass, and visible light from the light sources is introduced into the glass window to generate luminance at a main surface of the glass window. The luminance may be achieved by visible light scattering at particles such as indium tin oxide and/or titanium oxide in a glass lamination. Some art describes the particles as dissolved either in a polymeric matrix or in a screen print paint.

### BRIEF SUMMARY OF THE EXEMPLARY EMBODIMENTS

The disclosed exemplary embodiments are generally directed to laminated glazings having a lighting capability for architectural and automotive applications, such as automotive sunroofs.

According to one exemplary embodiment, a laminated glazing includes first and second glass sheets, a light guide film provided between the first and second glass sheets, a light source for introducing light into the light guide film, a first adhesive layer positioned between the first glass sheet and the light guide film, and a second adhesive layer positioned between the second glass sheet and the light guide film, wherein the light guide film extends out of the first and second glass sheets.

In some embodiments, the light source may be positioned along an outer surface of the second glass sheet. The light guide film may be wrapped around the second glass sheet. The radius of curvature where the light guide film is wrapped may be about half of a thickness of the second glass sheet. The light guide film may include a silicone core layer positioned between a first carrier film and a second carrier film, and the first and second carrier film may be formed of a polymer or polymers, such as e.g., polyethylene terephthalate. The first adhesive layer and the second adhesive layer may have thicknesses different from each other. In a further embodiment, at least one of the first adhesive layer and the second adhesive layer may have a thickness of 0.3 mm or less. Further, the light guide film may extend beyond an edge of the first glass sheet and an edge of the second glass sheet.

In some embodiments in which the laminated glazing is applied for a vehicle such as, e.g., a sunroof for a vehicle, the second glass sheet may face a vehicle interior where an outer major surface of the second glass sheet may include a recess within which the light source may sit. The laminated glazing may be encapsulated. The light guide film may extend through an opening formed in the second glass sheet. The opening in the second glass sheet may be a hole formed through the second glass sheet. The second glass sheet may include two pieces separated from each other at the opening in the second glass sheet. The light guide film may include a fluorescent or light diffusing material as a light extraction means. The light extraction means may be printed or etched on the light guide film in a designed pattern.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates a cross section of a laminated glazing according to an exemplary embodiment described herein;

FIG. 2 illustrates a cross section of a laminated glazing according to an exemplary embodiment described herein;

FIG. 3 illustrates a cross section of a laminated glazing according to an exemplary embodiment described herein;

FIG. 4 illustrates a cross section of a laminated glazing according to an exemplary embodiment described herein;

FIG. 5 illustrates a cross section of a laminated glazing according to an exemplary embodiment described herein;

FIG. 6 illustrates a cross section of a laminated glazing according to an exemplary embodiment described herein;

FIG. 7 illustrates a cross section of a light guide film as described herein;

FIG. 8 illustrates a pattern of light extraction means across a light guide film;

FIG. 9 illustrates a pattern of light extraction means across a light guide film;

FIG. 10 illustrates a schematic bottom view of the laminated glazing shown in FIG. 1;

FIG. 11 illustrates a cross section of a laminated glazing according to an exemplary embodiment described herein; and

FIG. 12 illustrates a schematic bottom view of a laminated glazing with multiple light guide films according to an exemplary embodiment described herein.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below.

Among other features, the present disclosure provides a glazing having a lighting capability. A light may be desired for various functions in a vehicle, including providing ambient light. As disclosed herein, it may be particularly useful to provide such lighting in a vehicle above vehicle occupants, including in a sunroof. In some embodiments, a lighting solution may be provided such that, when the lighting is turned off, the sunroof may have a transparency of from 2% to 15%, more preferably from 5% to 10%.

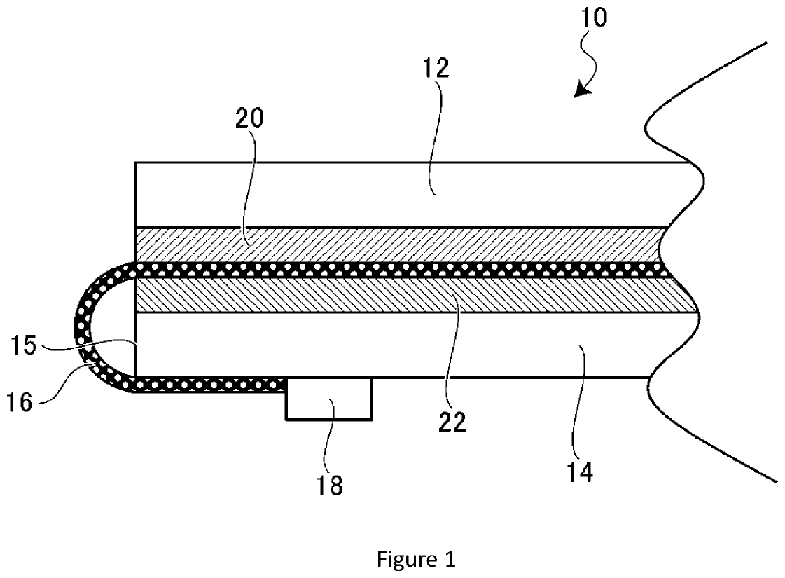

A sunroof of a vehicle may have a lighting system to provide ambient lighting capabilities. Preferably, a lighting system may have a light guide film which may be laminated within a sunroof glazing, as shown in FIG. 1. The glazing 10 may include a first glass sheet 12 and a second glass sheet 14 having a light guide film 16 therebetween. The light guide film 16 may be positioned between a first adhesive layer 20 and a second adhesive layer 22 within the laminated glazing 10. The thicknesses of the first and second glass sheets 12, 14 are not particularly limited, but are preferably from 0.5 mm to 3 mm, more preferably from 1 mm to 2.5 mm. The glass sheet may include, without limitation, soda-lime silicate glass described by ISO 16293-1:2008. The first adhesive layer 20 and the second adhesive layer 22 may be the same or different materials from each other. The adhesive layers 20, 22 may include a polymer based adhesive, such as a polyvinyl butyral. In certain embodiments, at least one of the adhesive layers 20, 22 may have a thickness of 0.3 mm or less. The laminated glazing described herein may include one adhesive layer having a thickness of 0.3 mm or less and another adhesive layer having a thickness of at least 0.35 mm or greater. In some embodiments, the light guide film 16 may have a thickness of 0.05 mm to 0.5 mm. Where the light guide film has a thickness of less than 0.35 mm, it may be preferable to provide at least one thin adhesive layer to provide a good lamination result. During a lamination process, a thin film positioned between thick adhesive layers may be prone to forming waviness and defects in the film, as the film 16 may move around between the adhesive layers 20, 22 during lamination. The thin adhesive layer may improve lamination and allow the light guide film 16 to keep its shape without wrinkling when pressure pushes the film more against the glass sheet shape, which may be curved. In some further embodiments, the light guide film 16 may have suitable strength to withstand the lamination process and may not require a thin adhesive layer. Such a film may be positioned between two adhesive layers having a thickness of at least 0.35 mm.

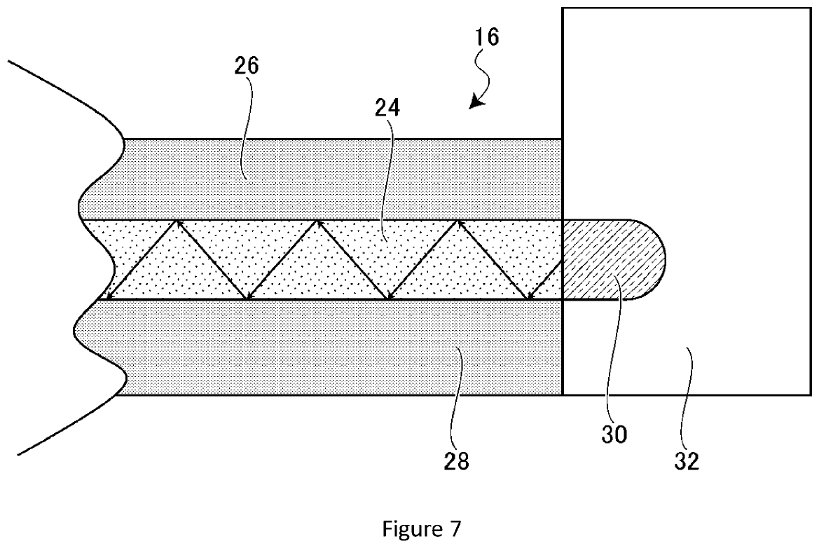

The light guide film 16 may include outer carrier film layers 26, 28 with a silicone core layer 24, which may serve as the light guide, as shown in FIG. 7. The silicone core layer 24 may have an index of refraction different from the carrier film layers 26, 28 such that light introduced to the silicone core 24 may be reflected within the core layer 24. The light may be introduced, for example, by a light emitting diode (LED) 30. The LED 30 may be held in a housing 32 in position to emit light directly into the silicone core layer 24. This structure may produce total internal reflection of the light to occur so any light inside the film 16 is confined until extracted. Preferably, the silicone core may have an index of refraction higher than that of the carrier film layers 26, 28. The light guide outer carrier film layers 26, 28 may include polymer films, such as polyethylene terephthalate. The light guide film 16 may have a visible light transparency across the glazing such that light may transmit through the glazing, including into the vehicle. The light guide film 16 may be flexible such that it may be laminated between the curved first and second glass sheets 12, 14. The light may be reflected at the light guide film core's surfaces with total internal reflection such that the light guide film 16 acts as an optical waveguide. Edges of the light guide film 16 may also be treated to aid confinement of the light to the inside volume of the core layer 24. The light guide film 16 may have suitable flexibility such that the light guide film 16 may not be damaged even where bent between glass sheets 12, 14. The light guide film 16 may be flexible enough to be wrapped around an edge 15 of the second glass sheet 14 without damaging the film 16. By controlling the density of the scattering centers, the intensity of the illumination can be made uniform over the entire display instead of being excessively bright near the illumination edge.

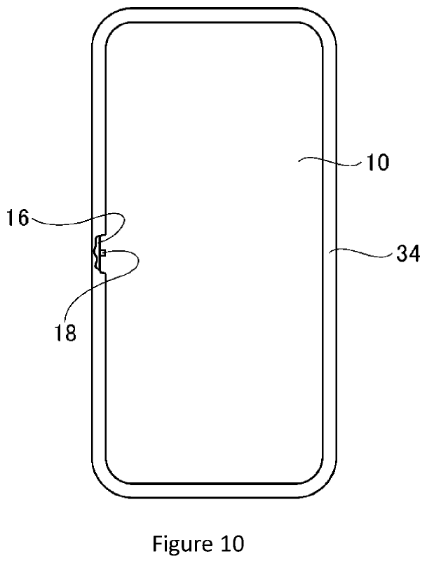

A sunroof may have a three-dimensional shape, which may be bent in at least one direction, preferably more than one direction. The first and second glass sheets 12, 14 may be bent by methods known in the art, which include gravity or press bending. The light guide film 16 may have suitable flexibility to conform to a shape of the laminated glazing. FIG. 10 shows an example of a laminated glazing 10 for a sunroof of a vehicle. The light guide film 16 may cover a majority or all of the glazing 10. In some embodiments, the light guide film 16 may be across a part of the laminated glazing 10. In FIG.10, a part of a glass frame 34 near the light source 18 is cut out for the purpose of illustration, and the light source 18 is shown on the glass sheet. The glass frame 34 may be provided as an encapsulating means for providing a desired edge on the glazing to fit the laminated glazing to a seat formed at a vehicle roof frame as well as preventing exterior gas and liquid from encroaching into the edge of the glass sheets 12, 14. The laminated glazing 10 may have a corner-rounded rectangular sunroof shape. An entire edge of the laminated glazing 10 may be covered with a glass frame 34. In this embodiment, a light source 18, as shown in FIG. 10, may be mounted on a major surface of the second glass sheet 14 and covered with the glass frame 34.

A light introduction mechanism may be utilized for introducing light to the light guide film 16. The light may be introduced to the silicone core layer 24 of the light guide film 16 at an angle greater than a critical angle, such that total internal reflection of the light is possible within the silicone core layer 24. The critical angle may be measured with respect to the normal to the carrier film surface. Preferably, the carrier film layers 26, 28 are parallel to each other, such that the silicone core layer 24 has an even thickness across the laminated glazing 10. The light may not pass through the bounds of the light guide core layer 24 where the light guide core layer 24 has a higher refractive index than its surroundings (the carrier layer 26, 28) and the reflective angle is greater than a critical angle. The light's angle is greater as it moves towards parallel with the light guide carrier layers 26, 28. The critical angle may depend on the core layer 24 and carrier layers 26, 28, including their refractive indices. Particularly, the critical angle, Oc, may be defined by equation (I):

$${θ}_{c} = arc sin ( \frac{{n}_{2}}{{n}_{1}} )$$

wherein θ_{c} is the critical angle, n₂ is the refractive index of the carrier layers 26, 28, and n₁ is the refractive index of the core layer 24.

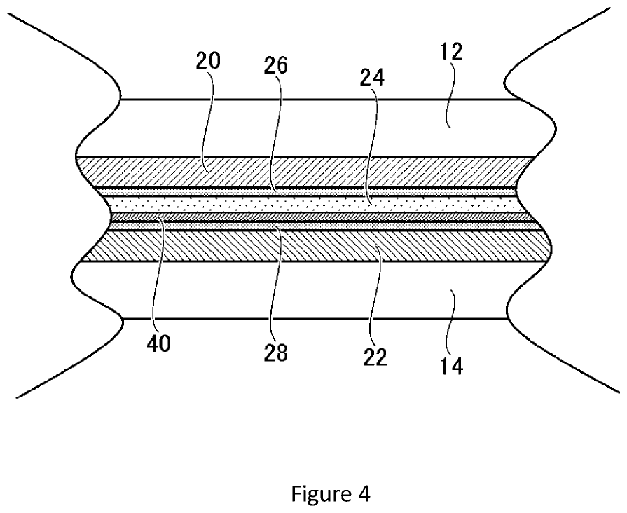

The laminated glazing 10 may be produced such that the light introduction mechanism may be positioned outside of the first and second glass sheets 12, 14. The light introduction mechanism may be at an edge of the laminated glazing 10 or it may be positioned along an interior side of the laminated glazing 10, where the interior side of the laminated glazing faces a vehicle interior, as shown in FIG. 1. The light guide film 16 may be flexible enough to allow the film 16 to bend around the glass edge 15. The light introduction mechanism may preferably include a light source 18 mounted on the outer surface of the second glass sheet 14 which faces a vehicle interior, as shown in FIG. 1. The light source 18 may include one or more light elements such as LEDs 30, which may be connected to the light guide film 16. The light may be any desirable color or colors, including white. The light may be extracted from the light guide film 16 by diffraction or luminescence. The film 16 may further include a printed, fabricated, or etched pattern. The print or pattern may be visible, in some embodiments, when the light is on and when the light is off. Preferably, where there is a printed portion 40 on the light guide film 16, the printed portion 40 of the light guide film 16 faces a vehicle interior, as shown in FIG. 4.

The printed portion 40 may particularly be on a surface in contact with the light guide core layer 24.

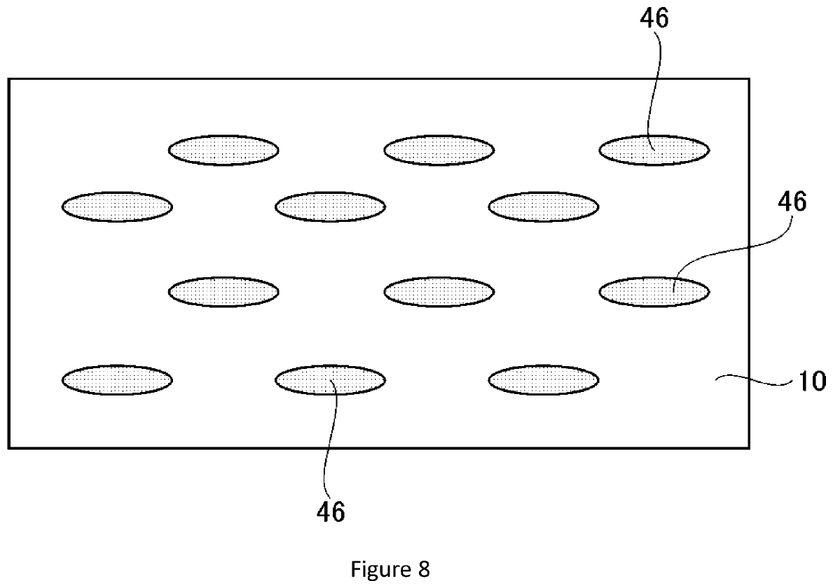

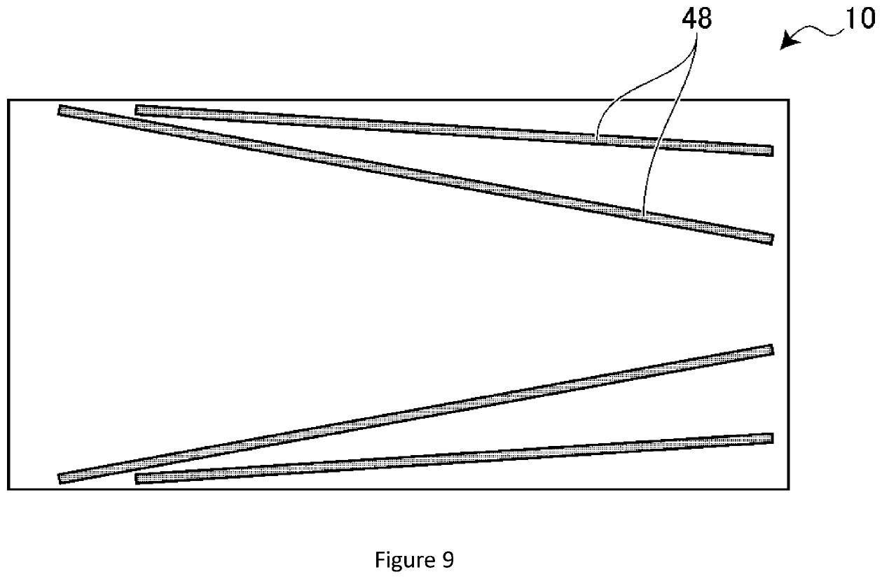

A laminated sunroof may have a printed pattern 46, 48 of light extracting means. The light extracting means may include luminous particles or diffusing particles, such as, for example, nitrides such as (SrCa)AlSiN₃: Eu²⁺, oxides such as Y₃Al₅O₁₂:Ce³⁺ and Lu₃Al₅O₁₂:Ce³⁺, II-VI semiconductor compounds such as zinc sulfide, cadmium sulfide, zinc selenide, cadmium selenide, zinc telluride and cadmium telluride, and organic compounds such as dialkyl-dihydroxy-terephthalate. The printed designs 46, 48 may have various patterns or structures, for example, as shown in FIGS. 8 and 9. Preferably the light extracting means may be transparent, such that light may pass through the means when the light source 18 is not directing light to the light extracting means, however, the haze at a printed light extraction means may be higher than in a surrounding non-printed area. The light source 18 may be positioned to ensure an appropriate light distribution for the printed pattern 46, 48. For example, LEDs may be positioned in a position near the print such that the light may be readily directed to the light extraction means. Further, a print having extraction means on different sides of a glazing may preferably have light sources 18 positioned on the different sides of the glazing.

A laminated glazing 10 having a light guide film 16 may include a sunroof. A sunroof is positioned on top of a vehicle and may be exposed to significant sunlight over a life of the glazing 10. The sunroof having such a film 16 may preferably include a dark outer glass sheet, or a privacy glass. Such glass may include grey-colored glass. The privacy glass may reduce the amount of sunlight which reaches a vehicle interior and improve comfort of any vehicle occupants. The darkened color may further provide a background for the ambient lighting. In some embodiments, the interior glass sheet may be a clear or green glass. The color of the light administered via the laminated light guide film 16 may be determined based on a color of the interior glass sheet to provide a desired aesthetic lighting toward the vehicle interior.

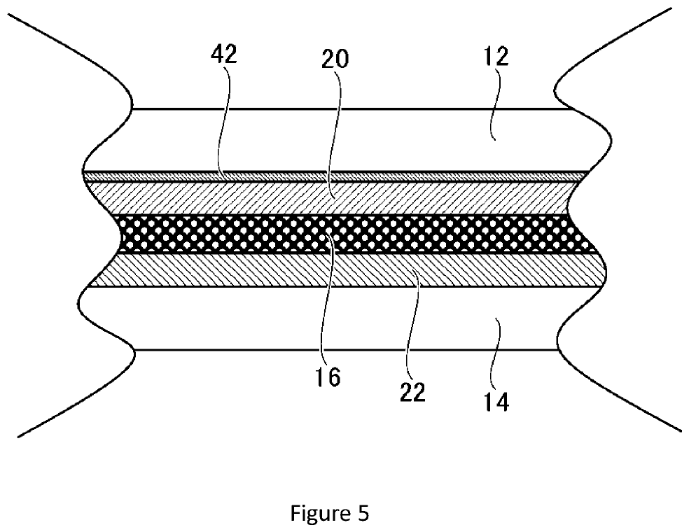

A laminated sunroof may further include an infrared reflective (IRR) layer 42 as shown in FIG. 5. The IRR layer 42 may include a coating, which may include at least one reflective layer and dielectric layers. The at least one reflective layer may include a metal, (such as silver, gold, etc.) or a transparent conductive oxide (such as indium tin oxide). The IRR layer 42 may be provided on a glass sheet or on a film and may preferably be positioned between the light guide film 16 and the vehicle exterior. Where an IRR coating is provided on a glass sheet, the coating may preferably be provided on an interior surface of the first glass sheet 12 serving as the outer glass sheet, such that the IRR coating is positioned between the first glass sheet 12 and the light guide film 16, as shown in FIG. 5. An IRR coating may further be provided on a film, such as a polyethylene terephthalate film, which may be a part of or separate from the light guide film 16. For example, a film having an IRR coating may be laminated between the first glass sheet 12 and the light guide film 16. Such a construction may include a third adhesive layer, such that the IRR film is positioned between two adhesive layers. In some embodiments, the IRR coating may be provided on a carrier film of the light guide film 16. Preferably, such an IRR coating may be provided on an outer surface of the carrier film 26, facing a vehicle exterior.

It may be preferable, in some embodiments, to include an IRR layer 42 without a darkened, or privacy, layer positioned between the IRR layer and a vehicle exterior. A darkened layer outside of the IRR layer 42 may absorb some of the reflected infrared light. In some embodiments, a darkened layer may be provided between an IRR layer 42 and the light guide film core 24. The darkened layer may be provided in a film or an adhesive layer. For example, a darkened adhesive layer may be provided between the IRR layer 42 and the light guide film 16.

In some embodiments, a darkened film may serve as an IRR coating carrier film or a carrier film 26 for the light guide film 16.

The laminated sunroof described herein may further include a low-E coating on a surface facing a vehicle interior. The outer surface of the inner glass sheet 14 may include such a coating. The low-E coating may include, for example, a transparent conductive oxide (such as indium tin oxide) layer and dielectric layer(s). The low-E coating may increase internal comfort in the vehicle. Some embodiments may include both an IRR layer and a low-E coating.

In a laminated glazing, the light guide film 16 may have a main portion positioned between first and second glass sheets 12, 14 and an external portion outside the first and second glass sheets 12, 14 for connection to a light source 18. In some embodiments, the light guide film 16 may extend beyond an edge of the first and second glass sheets, as shown in FIG. 1. The external portion may include a wrapped portion 16b which may be wrapped around the edge 15 of a glass sheet 14 in the glazing so that the film 16 and a light source 18 may be positioned along a major surface (outer surface) of the second glass sheet 14. The radius of curvature of the film where it is wrapped may be smaller than 1.5 mm, preferably smaller than 1.2 mm. The radius of curvature at the wrapped portion of the film 16 may preferably be about or a little more than half of the inner glass thickness in some embodiments. The radius of curvature where the film 16 is wrapped may be minimized to ensure a light coupling which uses a minimal amount of space.

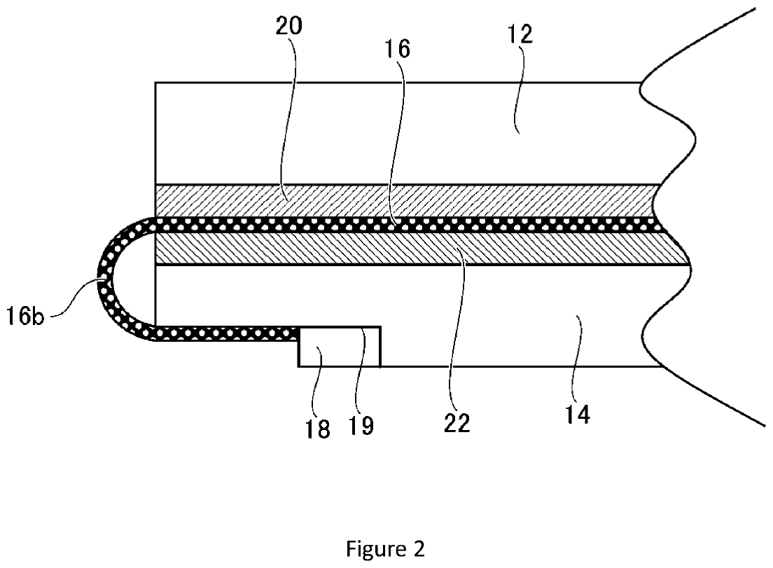

The second glass sheet 14 may include a recess 19 for positioning of the light guide film 16 and light source 18, as shown in FIG. 2. Any suitable means may be used to make the recess structure, including chemical etching. In certain embodiments, a chemical etching process may include the use of a mask to determine and isolate a location(s) of the recess structure where an etching material is applied. Any suitable chemical etching materials may be used, such as hydrofluoric acid solution, nitric acid solution, sulfuric acid solution, ammonium fluoride solution, ammonium hydrogen fluoride, or any combinations thereof.

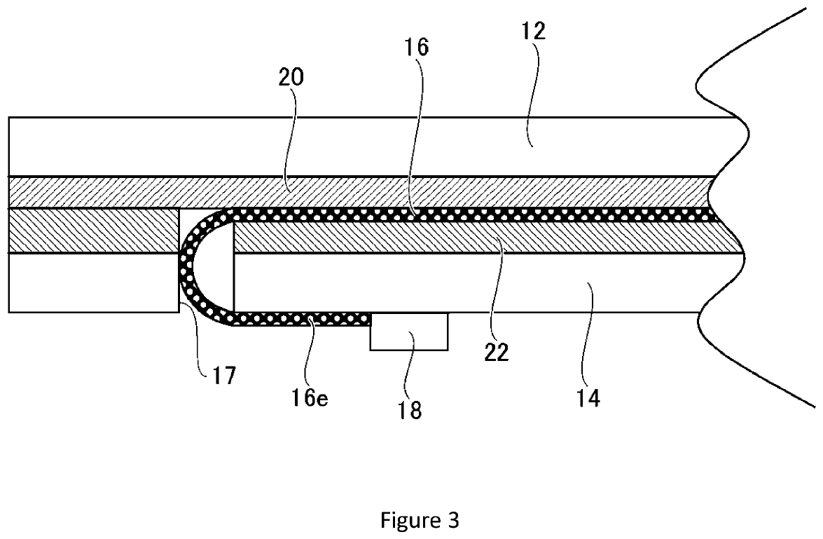

In some further embodiments, an opening 17 may be formed in the second glass sheet 14 for passage of the light guide film 16. The light guide film 16 may extend through the opening 17, as shown in FIG. 3. The light guide film 16 may extend over the surface of the second glass sheet 14, and the end of an external portion 16e of the light guide film 16 may directly couple with the light emitting face of the light source 18. The external portion 16e of the light guide film 16 may extend over the surface of the second glass sheet 14 in either direction from the opening 17. In some embodiments, the light guide film 16 may extend through the opening 17 such that the light source 18 is positioned between an edge of the glazing and the opening 17 where the light source 18 may not overlap with a laminated portion of the light guide film 16. In some embodiments, the external portion 16e of the light guide film 16 may wrap around the second glass sheet 14 such that the light source does align with the laminated portion of the light guide film 16, as shown in FIG. 3. The opening 17 may be formed as an extended hole in the second glass sheet 14 which the light guide film 16 may be passed through during production of the laminated glazing 10. Alternatively, the opening 17 may be a cut in the second glass sheet 14 such that the second glass sheet 14 is provided in a main portion and a secondary portion. The secondary portion of the second glass sheet 14 may, for example, extend along an edge of the glazing. The opening 17 may have a width such that the light guide film 16 may extend through the opening 17. The opening 17 may be any suitable shape for wrapping of the light guide film 16, including a straight shape relative to the film.

A bend in the light guide film 16 may allow for the light source 18 to be adjacent to a main surface of the main portion of the second glass sheet 14. Where an opening 17 is provided in the second glass sheet 14, the opening 17 may further have a width at least the length of the radius of curvature where the light guide film 16 is wrapped around the edge 15 of the second glass sheet main portion. In some embodiments, the opening 17 may be wide enough that the light source 18 attached to the light guide film 16 may pass through the opening 17, particularly where the opening 17 is a hole. The opening 17, as a through-hole or a cut, may be formed by any suitable means, including mechanical drilling, laser cutting, water jet cutting, or chemical etching, and may be done before or after a glass sheet is bent. It may be preferable to further fill the opening 17 with an epoxy or a polyurethane around the light guide film 16. In some embodiments, the laminated glazing 10 may preferably have a consistent thickness around an entire edge of the glazing, such that installation in a vehicle may be simplified.

The laminated glazing may be encapsulated. One of the encapsulated laminated glazings is shown in FIG. 10. The encapsulation around the glazing edge may cover or partially cover the external portion of the light guide film 16 and light source 18. The encapsulation may protect the light guide film 16 at a wrapped portion and provide a suitable installation surface for the glazing 10. The light guide film 16 may be protected in some embodiments by a bracket or protective casing, such as the glass frame 34, which may fit around the light guide film 16 and/or the light source 18. The glass frame 34, serving as a protective means, may protect the film 16 and/or light source 18 from pressures or damage from installation of the glazing and from the view of an observer in the vehicle. The glazing may have a short length and a long length, such as a front or back and side of a sunroof, respectively. The light guide film may wrap around a short length or a long length of a glazing. In some embodiments, the light guide film 16 may wrap around more than one length, such as wrapping around a long length and a short length of the glazing. Where the film wraps around two glazing lengths which meet each other, there may be a notch in the film to facilitate the film wrapping. An encapsulation material may be thermosetting or a thermoplastic resin, and may be, e.g., epoxy resin, phenolic resin, polyimide, polyurethane, ABS (acrylonitrile butadiene styrene) resin, polycarbonate, acrylic resin, polyamide, POM (polyacetal) resin, PBT (poly butylene terephthalate) resin, etc., or a combination of those resins, fiber reinforced resin materials, elastomers, etc.

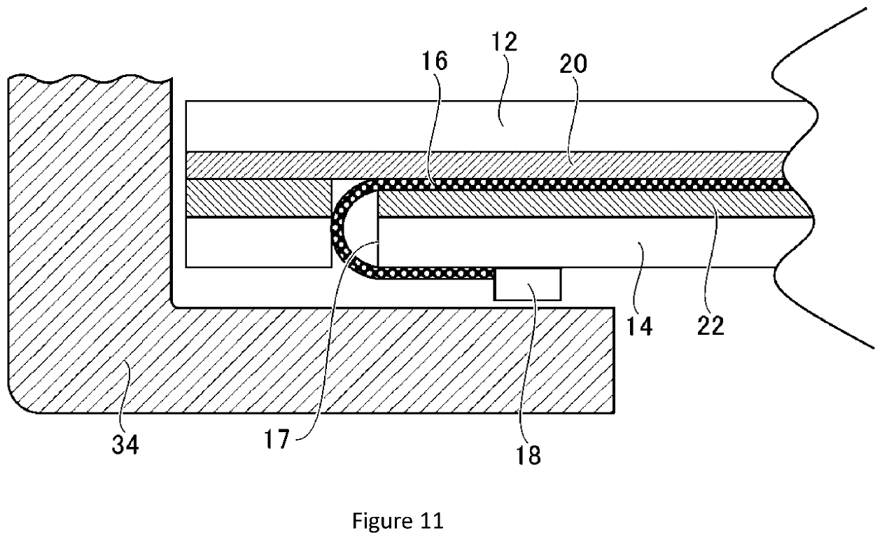

FIG. 11 shows a portion of an encapsulated laminated glazing having a glass frame 34. A glass frame 34 may serve as a protective means for the light guide film 16 covering the opening 17 and the light source 18. The light guide film 16 may be curved through the opening 17 such that the entire light guide film 16 is within the area of the glass sheets 12, 14 and the glass frame 34 may be formed to fit around such curvature. If the light guide film 16 extends over the edges of the first and second glass sheets 12, 14, a glass frame 34 may be required to receive the extended light guide film 16 or part of the extended light guide film 16.

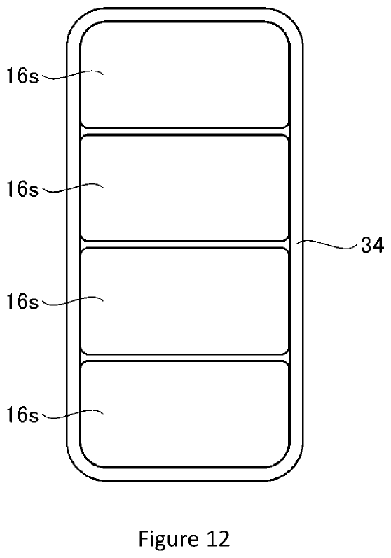

FIG. 12 illustrates a laminated glazing 10 having multiple, e.g., four, light guide films 16s covering the entire surface of the glass sheet. Each of the four light guide films 16s may have one or more light sources, not shown, which are coupled to the respective light guide films 16s in a manner to introduce light into the respective light guide films 16s. With this structure, the laminated glazing 10 can be illuminated partly and separately. If the light guide films 16s have portions to emit light guide through the light guide films 16s, the light may be outputted from the portions on the laminated glazing 10 at the same time, strength, and color as well as with different times, strengths, or colors. The laminated glazing 10 according to this disclosure may be formed of any number of the light guide films 16s as far as the light can be outputted adequately. The edges of two light guide films 16s may be separated from each other.

The light source 18 may be one of a LED, Laser, halogen, OLED, fluorescent or other light sources. An LED light source may in particular be white light, a colored light or mixed red, green, and blue RGB LEDs.

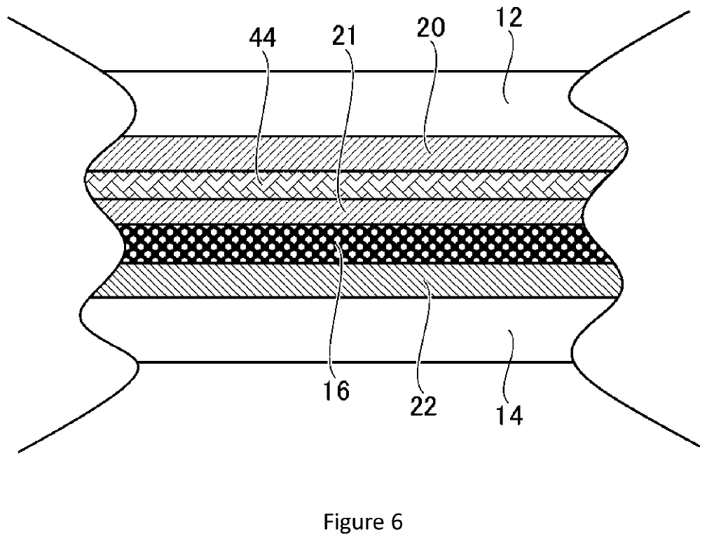

In some further embodiments, the laminated sunroof may further include a switchable film 44 as shown in FIG. 6. A switchable film 44, such as a liquid crystal based film, may be electrically controlled to switch between a transparent state and an opaque state. A switchable film 44 may be laminated between glass sheets 12, 14 to provide a switchable glass construction. The switchable film 44 may be laminated in a glazing with the light guide film 16. Where there is a pattern in the light guide film 16, a switchable film 44 in an opaque state may provide a background for viewing the pattern, even during daylight hours. The switchable film 44 may be controlled separately from the light guide film 16, such that a vehicle occupant may choose their desired sunroof conditions with respect to transparency and lighting independently. Preferably, a switchable film 44 may be laminated to an exterior of the light guide film 16, as shown in FIG. 6. A third adhesive layer 21 may be provided between the laminated films 44, 16.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A laminated glazing, comprising:
a first glass sheet;
a second glass sheet;
a light guide film provided between the first glass sheet and the second glass sheet;
a light source for introducing light into the light guide film;
a first adhesive layer positioned between the first glass sheet and the light guide film; and
a second adhesive layer positioned between the second glass sheet and the light guide film,
wherein the light guide film extends out of the first glass sheet and the second glass sheet.

2. The laminated glazing according to claim 1, wherein the light source is positioned along an outer surface of the second glass sheet.

3. The laminated glazing according to claim 1, wherein the light guide film is wrapped around the second glass sheet.

4. The laminated glazing according to claim 3, wherein the radius of curvature where the light guide film is wrapped is about half of a thickness of the second glass sheet.

5. The laminated glazing according to claim 3, wherein the light guide film comprises a silicone core layer positioned between a first carrier film and a second carrier film.

6. The laminated glazing according to claim 5, wherein the first carrier film and the second carrier film are polymer films.

7. The laminated glazing according to claim 6, wherein the first carrier film and the second carrier film are polyethylene terephthalate films.

8. (canceled)

9. (canceled)

10. The laminated glazing according to claim 1, wherein the light guide film extends beyond an edge of the first glass sheet and an edge of the second glass sheet.

11. The laminated glazing according to claim 1, wherein the second glass sheet faces a vehicle interior and an outer major surface of the second glass sheet includes a recess, and wherein the light source sits within the recess.

12. The laminated glazing according to claim 1, wherein the first glass sheet is a privacy glass sheet.

13. The laminated glazing according to claim 1, further comprising a switchable film.

14. (canceled)

15. The laminated glazing according to claim 1, wherein the light guide film extends through an opening formed in the second glass sheet.

16. The laminated glazing according to claim 15, wherein the opening in the second glass sheet is a hole formed through the second glass sheet.

17. The laminated glazing according to claim 15, wherein the second glass sheet includes two pieces separated from each other at the opening in the second glass sheet.

18. The laminated glazing according to claim 1, wherein the light guide film includes a fluorescent or light diffusing material as a light extraction means.

19. The laminated glazing according to claim 1, wherein a light extraction means is printed or etched on the light guide film in a designed pattern.

20. (canceled)

21. (canceled)

22. The laminated glazing according claim 1, wherein the light guide film covers part of the laminated glazing.

23. The laminated glazing according to claim 1, wherein the light guide film covers all of the laminated glazing.

24. The laminated glazing according to claim 1, wherein the laminated glazing comprises multiple light guides.

25. The laminated glazing according to claim 1, wherein the laminated glazing is structured for a sunroof for a vehicle.
